(19) United States
(12) Patent Application Publication
(10) Pub. No.: US 2015/0346816 A1
(43) Pub. Date: Dec. 3, 2015

(54) DISPLAY DEVICE USING WEARABLE EYEGLASSES AND METHOD OF OPERATING THE SAME

(71) Applicant: MORIAHTOWN CO., LTD., Seoul (KR)

(72) Inventor: Sung-Ho LEE, Seoul (KR)

(21) Appl. No.: 14/526,060

(22) Filed: Oct. 28, 2014

(30) Foreign Application Priority Data
May 30, 2014 (KR) 10-2014-0065865

(51) Int. Cl. G06F 3/01; G06F 1/16; H04N 21/81; G06K 9/00; G02C 11/00; H04N 7/14

(52) U.S. Cl. CPC G06F 3/013; G02C 11/10; H04N 7/142; H04N 21/812; G06K 9/00671; G06F 1/163

(57) ABSTRACT

A display device and a method of operating the same are disclosed. The display device using wearable eyeglasses includes: a camera mounted on the wearable eyeglasses and photographing a first image based on a user's point of view; an operation unit analyzing the first image and determining a virtual display area of the wearable eyeglasses; a data cooperation unit receiving a second image from a smart device capable of cooperating with the wearable eyeglasses; and a display unit displaying the second image on the virtual display area. The second image cooperating with the smart device is displayed on the virtual display area determined by analyzing the first image based on the user's point of view, whereby advertising images, video calls or other special purpose image can be more effectively delivered to a user.

### CROSS-REFERENCE TO RELATED APPLICATION

This application claims priority to Korean Patent Application No. 10-2014-0065865 filed on 30 May 2014, and all the benefits accruing therefrom under 35 U.S.C. §119, the contents of which is incorporated by reference in its entirety.

### BACKGROUND

1. Technical Field

The present invention relates to a display device and a method of operating the same, and more particularly, to a display device using wearable eyeglasses and a method of operating the same.

2. Description of the Related Art

Wearable devices such as wearable computers have recently been developed. The wearable devices refer to anything that can be attached to the human body to perform a computing operation, and includes applications that can perform some computing functions. For example, the wearable devices may be provided in the form of products, such as watches, bracelets, headsets, and the like, and have functions of a computer. In particular, one example of the wearable device applied to eyeglasses includes “Google Glass”.

### BRIEF SUMMARY

It is an object of the present invention to provide a display device using wearable eyeglasses, in which a second image cooperating with a smart device is displayed on a virtual display area obtained by analyzing a first image based on a user's point of view, whereby an image for advertisement, video calling or other special purposes can be more effectively delivered to a user, and a method of operating the same.

The present invention is not limited to the object set forth above, and other objects and advantages of the present invention not mentioned above will be understood from the following description and become apparent by exemplary embodiments of the present invention. In addition, it will be easily appreciated that the objects and advantages of the present invention can be realized by features disclosed in the claims and combinations thereof.

In accordance with one aspect of the present invention, a display device using wearable eyeglasses includes: a camera mounted on the wearable eyeglasses and photographing a first image based on a user's point of view; an operation unit analyzing the first image and determining a virtual display area of the wearable eyeglasses; a data cooperation unit receiving a second image from a smart device capable of cooperating with the wearable eyeglasses; and a display unit displaying the second image on the virtual display area.

In accordance with another aspect of the present invention, a method of operating a display device using wearable eyeglasses includes: by a camera mounted on the wearable eyeglasses, photographing a first image based on a user's point of view; by an operation unit, analyzing the first image and determining a virtual display area of the wearable eyeglasses; by a data cooperation unit, receiving a second image from a smart device capable of cooperating with the wearable eyeglasses; and by a display unit, displaying the second image on the virtual display area.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a view of a display device using wearable eyeglasses according to one embodiment of the present invention;

FIG. 2 is a view showing a display screen of the wearable eyeglasses according to the embodiment of the present invention; and

FIG. 3 is a flowchart of a method of operating a display device using wearable eyeglasses according to one embodiment of the present invention.

### DETAILED DESCRIPTION

The foregoing aspects, features and merits will be described in detail with reference to the accompanying drawings, and thus the present invention can be readily embodied by a person having ordinary knowledge in the art. Detailed descriptions of components and functions related to the present invention and apparent to those skilled in the art will be omitted for clarity. Next, embodiments of the present invention will be described in detail with reference to the accompanying drawings. Like components will be denoted by like reference numerals throughout the drawings.

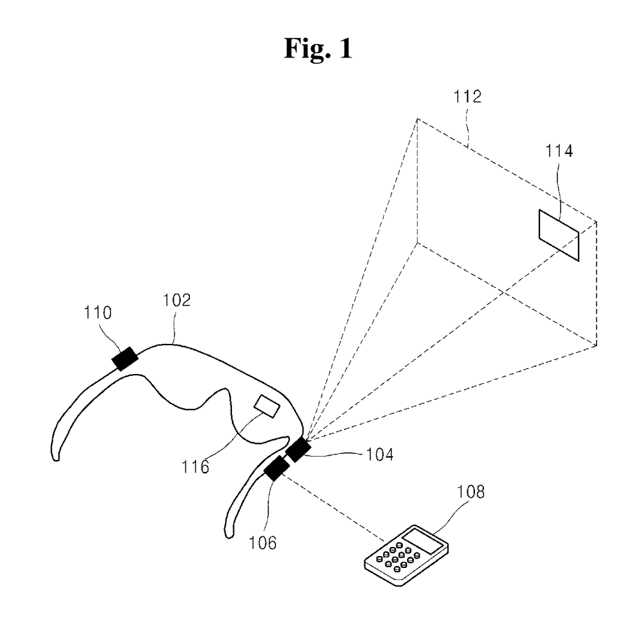

FIG. 1 is a view of a display device using wearable eyeglasses according to one embodiment of the present invention.

Referring to FIG. 1, a display device 102 using wearable eyeglasses according to one embodiment of the invention includes a camera 104 which photographs an image based on a user's point of view, an operation unit (not shown) which analyzes the image based on the user's point of view and determines a virtual display area, a data cooperation unit 106 which receives an image or data from a smart device 108 capable of cooperating with the wearable eyeglasses, and a display unit 110 which displays the image or the data received by the data cooperation unit 106 on the virtual display area of the wearable eyeglasses.

The camera 104 photographs the first image based on the user's point of view. The camera 104 is mounted on the wearable eyeglasses, and can photograph an image in a direction in which a user of the wearable eyeglasses looks. That is, the first image photographed by the camera 104 may show objects placed in a direction in which the user of the wearable eyeglasses looks.

The operation unit (not shown) analyzes the first image and determines the virtual display area of the wearable eyeglasses. As described above, the first image may show many objects placed in a direction in which the user of the wearable eyeglasses looks. The operation unit may recognize a contour of a certain object among many objects and determine the contour of the certain object as the virtual display area. For example, the first image may show a building, an electronic display board, a billboard, or the like, placed in a direction in which the user looks. The operation unit may recognize a contour of the electronic display and determine the recognized contour of the electronic display as the virtual display area.

In another embodiment of the invention, the virtual display area may be previously determined according to settings of a user. For example, a user may previously set a location of the virtual display area and a size of the virtual display area such that the virtual display area can be arranged at a desired location for the user.

A virtual display area 116 refers to an area in which data, image and the like will be displayed, and may correspond to a certain area 114 of a first image 112, as shown in FIG. 1. That is, when the virtual display area 116 displayed on the wearable eyeglasses is enlarged in front of a user, the virtual display area may correspond to the certain area 114 on an actual background.

In one embodiment of the invention, the operation unit recognizes a certain object by analyzing the first image, and updates the virtual display area of the wearable eyeglasses by tracking a changed location of the certain object as the recognized location of the certain object is changed by movement of a user. That is, when a contour of a certain object in the first image is determined as the virtual display area, it is determined that the contour of the certain object is changed by the movement of the user, and the location of the virtual display area on the wearable eyeglasses is updated by tracking the change of the contour. Although a relative location of the certain object with respect to the user is changed by the movement of the user, the virtual display area may be fixed with respect to the recognized certain object.

The data cooperation unit 106 functions to receive a second image or data from the smart device 108 cooperating with the wearable eyeglasses. The smart device 108 refers to smart phones, tablet personal computers (PC), or other electronic devices capable of transmitting and receiving data. The data cooperation unit 106 may cooperate with the smart device 108 through Bluetooth or Wi-Fi signals, and may be connected to the Internet through the smart device 108, thereby transmitting and receiving various kinds of data such as voice calls, images, messages, and the like. In particular, the data may include special purpose images or coordinate information related to the images.

The display unit 110 serves to display the second image on the virtual display area. The second image may be received from the smart device 108 cooperating with the wearable eyeglasses through the data cooperation unit 106, and include not only image information but also voice information related to an image and coordinate information related to advertising and other special purpose images. The virtual display area of the wearable eyeglasses may be determined by the operation unit (not shown).

As a method of the display unit 110 to display the second image on the virtual display area of the wearable eyeglasses 116, there are a method of projecting the second image onto the wearable eyeglasses, and a method of using the display unit 110 as a monitor for the wearable eyeglasses to directly display the second image.

In one embodiment of the invention, when the display unit 110 projects the second image to the wearable eyeglasses, a direction of projecting the second image may be adjusted such that the second image can be projected onto the virtual display area of the wearable eyeglasses 116.

In another embodiment of the invention, when the display unit 110 is used as the monitor for the wearable eyeglasses to display the second image, the display unit 110 combines the second image with the virtual display area 116 of the first image and displays a combined image.

Although not shown in FIG. 1, the display device using the wearable eyeglasses according to the embodiment of the invention may further include a controller (not shown) which can be manipulated by a user. The controller may receive a user command through a wearable device capable of cooperating with the wearable eyeglasses, or a voice or motion recognition function.

For example, a bracelet-shaped wearable device capable of cooperating with the wearable eyeglasses may be used to control operation of transmitting or receiving a message corresponding to motion of the bracelet. Further, the operation may be controlled through voice recognition. In addition, a user gesture may be recognized to control the operation corresponding to motion of the arm or fingers.

In the foregoing embodiments of the invention, the second image cooperating with the smart device is displayed on the virtual display area obtained by analyzing the first image based on the user's point of view, thereby more effectively delivering advertising images, video calls, or other special purpose images to a user.

In one embodiment of the invention, a special purpose image such as an advertising image, video call, and the like is reproduced at a location where the image is combined with a certain object placed within a visual field of a user, whereby the special purpose image or content can be more effectively delivered to the user.

For example, a fast-food restaurant located nearby a user may be searched for through a smart device of the user. When the wearable eyeglasses receives an advertising message of the fast-food restaurant through the smart device of the user, the display unit 110 displays the received advertising message. Then, the user checks the advertising message displayed on the wearable eyeglasses 202 and manipulates the controller to issue a command about whether to reproduce the advertising message. If the user issues a command to reproduce the advertising message, the data cooperation unit 106 receives an advertising image from the smart device under user control.

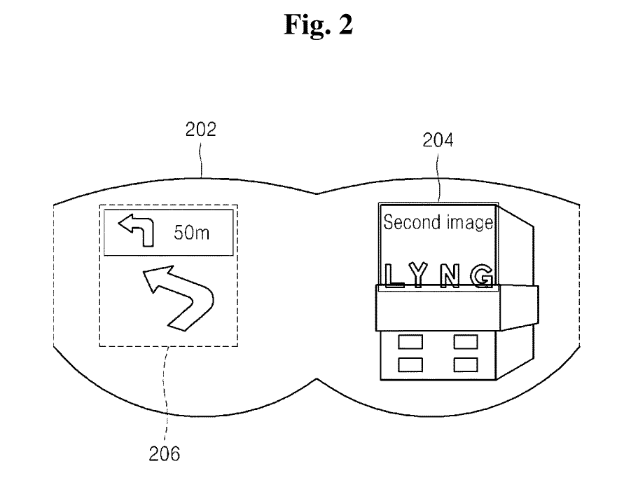

The user may view a screen as shown in FIG. 2, which is photographed by the camera of the wearable eyeglasses. FIG. 2 is a view showing a display screen of the wearable eyeglasses according to the embodiment of the present invention. The operation unit analyzes a first image photographed by the camera and determines the first image as the virtual display area. In more detail, the operation unit recognizes a contour 204 of a billboard on which an advertising message will be displayed, and determines the contour 204 of the recognized billboard as the virtual display area.

Referring to FIG. 2, guide data may be received through a smart device such that a user can reach a fast-food restaurant that is providing an advertising image. To this end, when coordinate information about the advertising message is received from the smart device, the data cooperation unit may receive the guide data for guiding the user from a current location to a location corresponding to the coordinate information based on current location information of the user and the coordinate information of the advertising message. The display unit may display the guide data on a guide screen 206 of the wearable eyeglasses 202, as shown in FIG. 2.

Preferably, the display device receives a special purpose advertising message selected corresponding to time and a location. For example, at lunchtime, the display device may be set to receive an advertising message related to a restaurant.

Alternatively, assume that a video call arrives at a smart device of a user. If a video call is requested from the smart device through the data cooperation unit, the user operates the controller to issue a command about whether to answer the video call. If the user answers the video call, the data cooperation unit receives video call data from the smart device under user control, and the display unit displays the video call data on a virtual display area previously designated by the user.

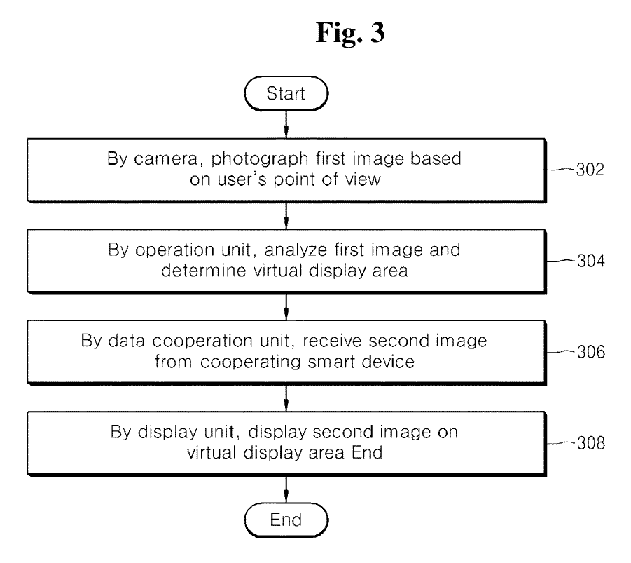

FIG. 3 is a flowchart of a method of operating a display device using wearable eyeglasses according to one embodiment of the invention. Referring to FIG. 3, a camera first photographs a first image based on a user's point of view (302). As described above, the camera is installed in a direction in which a user of wearable eyeglasses looks, and photographs the first image based on the user's point of view.

Then, an operation unit analyzes the first image and thus determines a virtual display area (304). Specifically, operation 304 may include analyzing the first image and recognizing a certain object, and updating the virtual display area of the wearable eyeglasses by tracking a changed location of the certain object when the recognized location of the certain object is changed as the user moves.

Then, a data cooperation unit receives a second image from a smart device capable of cooperating with the wearable eyeglasses (306). As described above, the smart device cooperates with a data cooperation unit through wireless connection, and transmits and receives data such as images, voice, and the like.

Lastly, a display unit displays the second image on the virtual display area (308). Operation 308 may be performed by one of a method of projecting the second image to the wearable eyeglasses, and a method of using the display unit as a monitor for the wearable eyeglasses to directly display the second image.

According to one embodiment of the invention, the second image may include a special purpose image or data. For example, when an advertising message arrives at the smart device, a user may issue a command about whether to receive the advertising message. In this example, if the user issues a command to receive the advertising message, operation 304 may include, by the operation unit, analyzing the first image and determining a billboard, on which the advertising message will be displayed, as the virtual display area. In addition, operation 306 may include, by the data cooperation unit, receiving the advertising image, and operation 308 may include, by the display unit, displaying the advertising image on the virtual display area. Further, operation 306 may include, by the data cooperation unit, receiving coordinate information about the advertising message, and by the data cooperation unit, receiving guide data for guiding the user from the current location to a location corresponding to the coordinate information based on current location information of the user and the coordinate information of the advertising message, if the coordinate information about the advertising message is received from the smart device. In this case, operation 308 may further include, by the display unit, displaying the guide data on the wearable eyeglasses.

Alternatively, a video call may be received through the user's smart device. In this case, operations 304 to 308 may include, by the operation unit, analyzing the first image and determining a virtual display area on which a video message will be displayed, by the data cooperation unit, receiving video call data from the smart device under user control, and by the display unit, displaying the video call data on the virtual display area, respectively. According to the present invention, picture-in-picture (PIP) and video-in-video (VIV) are applied to the wearable eyeglasses, thereby making it possible to more effectively deliver an advertisement and provide a targeted advertising effect. Further, a user can accept a video call and then shift and fix a video call screen to a desired location while wearing the wearable eyeglasses and walking even without lifting a smartphone.

As such, according to the present invention, the display device can display a second image cooperating with a smart device on a virtual display area determined by analyzing a first image based on a user's point of view, thereby more effectively delivering advertising images, video calls or other special purpose images to a user.

Although some embodiments have been described herein, it should be understood that various modifications, changes, alterations, and equivalent embodiments can be made by those skilled in the art without departing from the spirit and scope of the invention. Therefore, the scope of the invention should be limited only by the accompanying claims and equivalents thereof.

What is claimed is:

1. A display device using wearable eyeglasses, comprising:
a camera mounted on the wearable eyeglasses and photographing a first image based on a user's point of view;
an operation unit analyzing the first image and determining a virtual display area of the wearable eyeglasses;
a data cooperation unit receiving a second image from a smart device capable of cooperating with the wearable eyeglasses; and
a display unit displaying the second image on the virtual display area.

2. The display device according to claim 1, wherein the operation unit recognizes a certain object by analyzing the first image, and updates the virtual display area of the wearable eyeglasses by tracking a changed location of the certain object when the recognized location of the certain object is changed by movement of the user.

3. The display device according to claim 1, wherein, when an advertising message is received from the smart device,
the operation unit analyzes the first image and determines a billboard, on which the advertising message will be displayed, as the virtual display area,
the data cooperation unit receives an advertising image from the smart device under user control, and
the display unit displays the advertising image on the virtual display area.

4. The display device according to claim 3, wherein, when coordinate information about the advertising message is received,
the data cooperation unit receives guide data for guiding a user from a current location to a location corresponding to the coordinate information based on current location information of the user and the coordinate information of the advertising message, and
the display unit displays the guide data on the wearable eyeglasses.

5. The display device according to claim 1, wherein, when a video call is requested from the smart device,
the operation unit analyzes the first image and determines the virtual display area on which a video message will be displayed,
the data cooperation unit receives video call data from the smart device under user control, and
the display unit displays the video call data on the virtual display area.

6. The display device according to claim 1, further comprising:
a controller receiving a user command through at least one of a wearable device capable of cooperating with the wearable eyeglasses, voice recognition, and motion recognition.

7. A method of operating a display device using wearable eyeglasses, comprising:
by a camera mounted on the wearable eyeglasses, photographing a first image based on a user's point of view;
by an operation unit, analyzing the first image and determining a virtual display area of the wearable eyeglasses;
by a data cooperation unit, receiving a second image from a smart device capable of cooperating with the wearable eyeglasses; and
by a display unit, displaying the second image on the virtual display area.

8. The method according to claim 7, wherein analyzing the first image and determining the virtual display area of the wearable eyeglasses by the operation unit comprises:
recognizing a certain object by analyzing the first image, and updating the virtual display area of the wearable eyeglasses by tracking a changed location of the certain object when the recognized location of the certain object is changed by movement of a user.

9. The method according to claim 7, wherein, when an advertising message is received from the smart device,
the method further comprises:
by the operation unit, analyzing the first image and determining a billboard, on which the advertising message will be displayed, as the virtual display area;
by the data cooperation unit, receiving the advertising image from the smart device under user control; and
by the display unit, displaying the advertising image on the virtual display area.

10. The method according to claim 7, wherein, when coordinate information about the advertising message is received,
the method further comprises:
by the data cooperation unit, receiving guide data for guiding a user from a current location to a location corresponding to the coordinate information based on current location information of the user and the coordinate information of the advertising message; and
by the display unit, displaying the guide data on the wearable eyeglasses.

11. The method according to claim 7, wherein, when a video call is requested from the smart device,
the method further comprises:
by the operation unit, analyzing the first image and determining the virtual display area on which a video message will be displayed,
by the data cooperation unit, receiving video call data from the smart device under user control, and
by the display unit, displaying the video call data on the virtual display area.
